(19) United States
(12) Patent Application Publication
(10) Pub. No.: US 2008/0174107 A1
(43) Pub. Date: Jul. 24, 2008

(54) System and Method for Identifying Irrigation Fittings

(76) Inventor: Burl Jordan, Vista, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/626,237

(22) Filed: Jan. 23, 2007

(51) Int. Cl. F16L 35/00

(52) U.S. Cl. 285/18

(57) ABSTRACT

Irrigation fittings such as elbows, tees, couplings, adapters, or the like are provided in different colors based on the fitting size. Where there are three different fitting sizes, a first size fitting has a first selected identifying color over at least part of the outer surface of the fitting, a second size fitting has a second selected identifying color over at least part of the outer surface of the fitting, and a third size fitting has a third selected identifying color over at least part of the outer surface of the fitting. Each fitting may be made entirely out of a material in the selected identifying color for its size. The fittings are sorted according to color and placed in separate bins for easy size identification and selection based on the designated color for a desired size.

### BACKGROUND

1. Field of the Invention

The present invention relates to irrigation fittings such as tees, elbows, adapters and the like, and is particularly concerned with a system and method for identifying different size irrigation fittings.

2. Related Art

Irrigation fittings come in various types and sizes, and are typically manufactured in a single color, normally white, black or gray. The different types of irrigation fittings comprise elbows, tees, adapters, threaded couplings, and the like. Each particular fitting type comes in a variety of different sizes for fitting different diameter irrigation hoses. In home improvement stores or landscaping stores that sell landscape irrigation equipment, such fittings are normally displayed in bins each containing a particular size of fitting. However, over time, different size fittings end up in the same bin, either as a result of store personnel not recognizing the slight difference in size and re-filling the bin with the wrong size fitting, or customers picking out fittings to inspect them and then accidentally replacing them in the wrong bin. Because all the fittings in a bin are the same color, different-sized fittings that are accidentally placed in the wrong bin can be confused with the correct-sized fittings for a project. As a result, a customer may reach into a bin and grab a bunch of fittings, some of which end up being the wrong size. The customer then discovers that they cannot complete a job without returning to the store to exchange the incorrect fittings for the correct-sized fittings, resulting in additional time and inconvenience before a job can be completed.

Therefore, what is needed is a system and method that overcomes these significant problems found in the conventional systems as described above.

### SUMMARY

Embodiments described herein provide for a system and method for distinguishing different-sized irrigation fittings.

According to one embodiment, a system for identifying different sizes of one type of irrigation fitting is provided, which comprises a plurality of irrigation fittings of the same shape and configuration and at least three different sizes, the fittings comprising a plurality of first fittings of a first size, a plurality of second fittings of a second size different from the first size, and a plurality of third fittings of a third size different from the first and second sizes, each fitting having an outer surface, each of the first fittings having a first identifying color over at least part of the outer surface of the fitting, each of the second fittings having a second identifying color over at least part of the outer surface of the fitting, and each of the third fittings having a third identifying color over at least part of the outer surface of the fitting, the first, second and third identifying colors representing the first, second and third fitting size, respectively.

In one embodiment, each fitting is made entirely in the respective identifying color representing the fitting size, for example from colored plastic material or the like. Alternatively, a coating of colored material may cover some or the entire outer surface of the fitting. Fittings may come in more than three sizes, and in this case fittings of other sizes are provided in other, different colors. The fittings may comprise any type of irrigation fitting such as a tee, elbow, adapter, threaded coupling, or the like. In one embodiment, the same identifying color is used to represent the same size of different types of irrigation fitting. For example, a half inch elbow may have an identifying color which is yellow, and adapters, tees, threaded couplings, and the like of half inch size are also yellow. In this example, each three quarter inch fitting of any type may have a red identifying color, and each one inch fitting of any type may have a green identifying color, although other identifying colors may be used for these fittings and the half inch fitting in alternative embodiments.

The system may also comprise different containers or bins for holding the different color fittings, and each bin may be marked with the associated fitting color and size. Each type of fitting may be placed in a container based on its identifying color, and therefore its size. In one embodiment, the bins themselves may of the color associated with the fitting size to be placed in the bin. In another embodiment, labels/tags for the bins may of the color (or include the color) associated with the fitting size to be placed in the corresponding bin. In one example, a one half inch elbow container or bin contains yellow elbows which are all one half inch in size, a three quarter inch elbow container or bin contains red elbows which are all three quarter inch in size, and a one inch elbow container or bin contains green elbows which are all one inch in size. A key is provided indicating which particular color represents each standard fitting size. This is only one example, and different colors may be selected for each standard fitting size in other embodiments. Additional colors may be used where more than three different size fittings are available. Should any elbows be accidentally placed in the wrong bin, they stand out and are immediately visible to both store personnel and customers. This makes it unlikely for customers to select the incorrect size fitting.

According to another aspect, a method of identifying the size of irrigation fittings is provided, which comprises placing a plurality of first irrigation fittings of a first size in a first container, at least an external part of each first irrigation fitting having a first identifying color to identify the first size, placing a plurality of second irrigation fittings of the same type as the first irrigation fittings and of a second size different from the first size in a second container, at least an external part of each second irrigation fitting having a second identifying color different from the first identifying color to identify fittings of the second size, placing a plurality of third irrigation fittings of the same type as the first and second irrigation fittings and of a third size different from the first and second size in a third container, at least an external part of each third irrigation fitting having a third identifying color different from the first and second identifying color to identify fittings of the third size, and determining the size of a fitting of the type of the first, second and third fittings based on its color.

In one embodiment, the fittings are of plastic material or the like and are made entirely in the respective identifying colors based on their size. When a series of bins are placed side-by-side, with each bin containing fittings of a certain size and color, the different fitting colors stand out and allow a customer to readily pick out a fitting size based on its color.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1A illustrates a first irrigation fitting of a first size along with an identifying color key identifying the first size fitting;

FIG. 1B illustrates a second irrigation fitting of a second size along with an identifying color key identifying the second size fitting;

FIG. 1C illustrates a third irrigation fitting of a third size along with an identifying color key identifying the third size fitting;

FIG. 2 is a perspective view of one embodiment of an irrigation elbow fitting identification system using the fittings of FIGS. 1A to 1C.

### DETAILED DESCRIPTION

Certain embodiments as disclosed herein describe a method and system for identifying different size irrigation fittings. For example, one system as disclosed herein allows for identifying colors for different size fittings to allow each fitting size to be identified based on its appearance.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

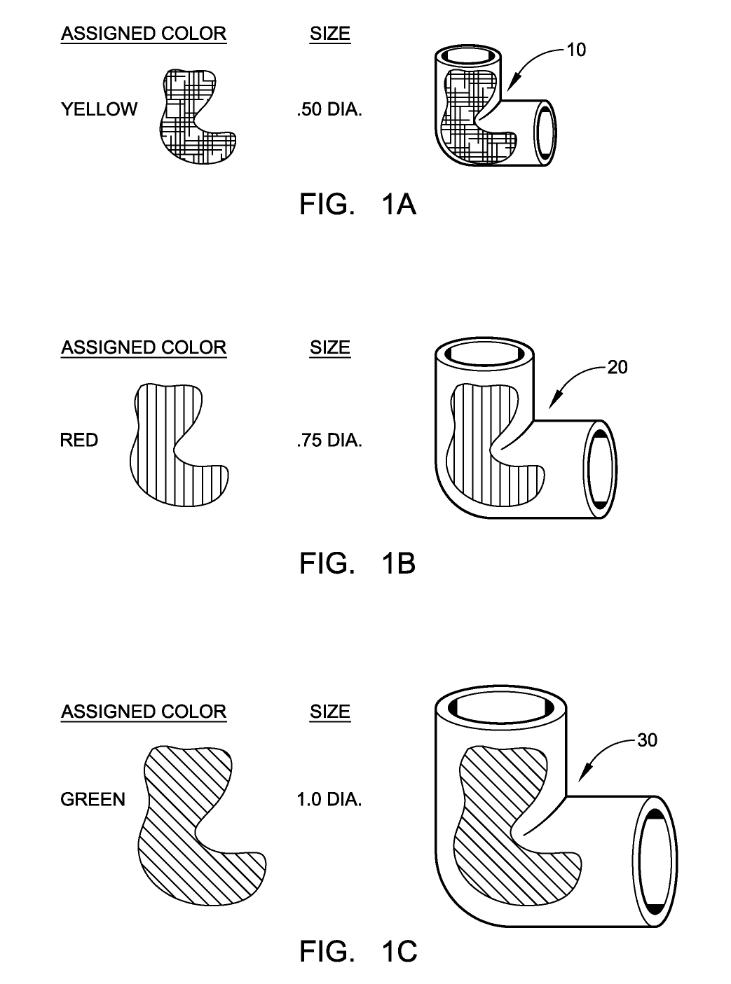

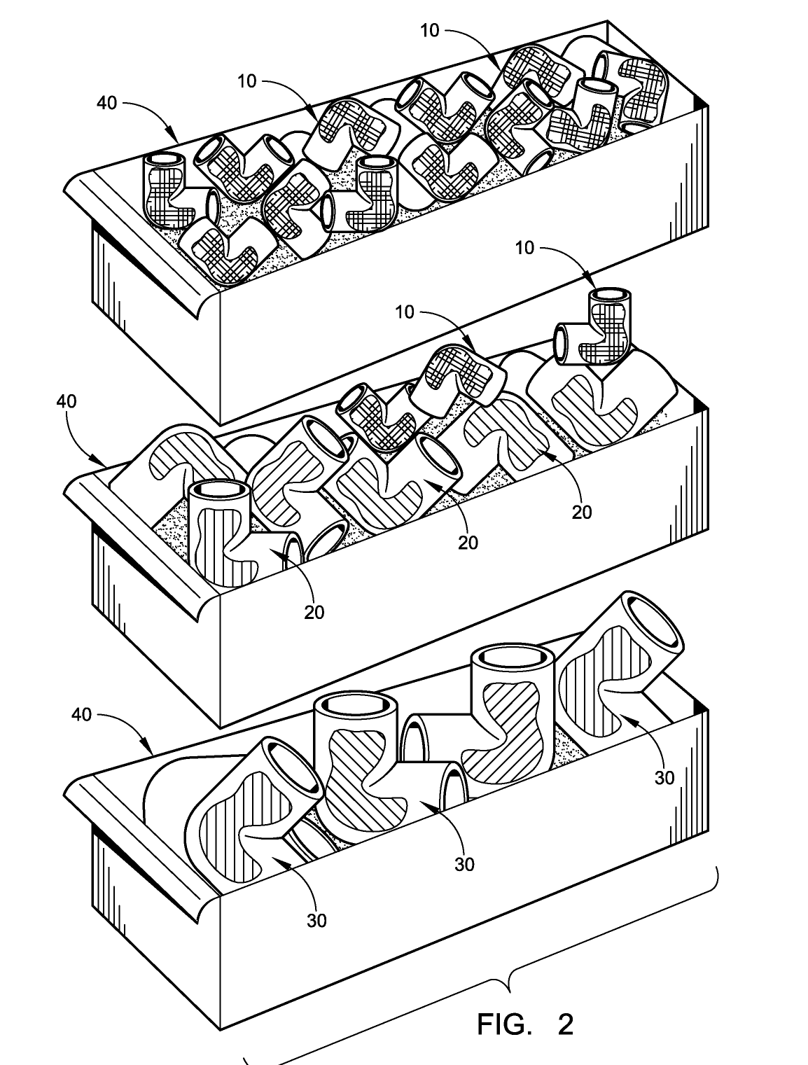

FIGS. 1A to 1C and 2 illustrate one embodiment of a system and method for identifying irrigation fittings. In the illustrated embodiments, the irrigation fittings are elbows for making a ninety degree bend in an irrigation system. However, the same system may be used for any type of irrigation fitting, such as elbows for making different angle bends, tees, adapters, and threaded couplings for making various joints, and the like. Irrigation elbows typically come in three different sizes for fitting standard irrigation pipes and hoses, specifically half inch, three quarter inch, and one inch. Although three different size elbows are illustrated, the same system may be used where there are more than three different size of fitting, by adding additional distinctive colors to the system for the additional fitting sizes.

The system illustrated in FIGS. 1 and 2 comprises a first irrigation elbow 10 of a first size (0.5 inches) having a first assigned identifying color (yellow), as illustrated in FIG. 1A, a second irrigation elbow 20 of a second size (0.75 inches) having a second assigned identifying color (red), as illustrated in FIG. 1B, and a third irrigation elbow 30 of a third size (1.0 inches) having a third assigned identifying color (green), as illustrated in FIG. 1C. Each fitting is made entirely in the assigned identifying color in one embodiment, or may have a coating of the assigned identifying color extending over all or part of the outer surface in alternative embodiments. Although only part of the outer surface of each elbow is shown shaded for the appropriate color in FIGS. 1A to 1C, in this embodiment each elbow is made entirely in one color, using a suitably colored material or material containing a dye, such as colored plastic, or by applying a coating of the identifying color. In this example, each elbow is made entirely in the assigned color, e.g. out of yellow, red, and green plastic, respectively, although different colors may be assigned to each size elbow in alternative embodiments, with the only requirement being that the colors are easily distinguishable from one another. Other additional or alternative colors may be used in other embodiments, such as blue, orange, black, purple, and the like.

In one embodiment, as illustrated in FIG. 2, a bin or open top container 40 is provided for each size of elbow, and the bins 40 may be placed side-by-side in a store or storage facility. In this example, a plurality of first elbows 10 which are yellow are placed in one bin, a plurality of second, larger elbows 20 which are red are placed in a second bin, and a plurality of the third, largest elbows 30 which are green are placed in the third bin. Additional bins for containing different size and color elbows may be provided if necessary. Similar bins may be provided for other standard irrigation fittings coded by different colors in a similar manner to the elbows of FIGS. 1A to 1C. In one embodiment, each type of irrigation fitting of a certain size has the same color. In one example, all one half inch fittings are colored yellow, all ¾ inch fittings are colored red, and all one inch fittings are colored green. In other words, the color code for one half inch irrigation fittings in this example is yellow, the color code for ¾ inch fittings is red, and the color code for one inch fittings is green. With such an arrangement, store personnel and irrigation system installers can soon learn that one selected color fitting is used with half inch irrigation hose, another selected color is used with three quarter inch hose, and so on.

Store personnel and others can easily sort elbows or other fittings for placing in the correct bins based on their color. When the elbows are correctly sorted in this embodiment, the first bin contains only yellow elbows 10, the second bin contains only red elbows 20, and the third bin contains only green elbows 30. If some elbows are accidentally placed in the wrong bin, such as the three yellow elbows 10 placed in the red elbow container in FIG. 2, it is immediately apparent to the observer that these three elbows are different from the other elbows in the bin, due to the distinctive difference in color between elbows 10 and elbows 20. The elbows 10 can therefore be easily distinguished from different size elbows 20, and can be replaced in the correct bin. A customer buying irrigation fittings can distinguish the proper size elbows desired for a project based on their color, and is unlikely to mix up fittings of different sizes, unlike the prior art where all fittings are the same color. A key or label (not illustrated) may be provided on each bin to indicate the color and size of the fittings contained in the bin, for example containing the information illustrated in FIG. 1A, 1B, or 1C, as appropriate.

As noted above, the colors yellow, red and green selected for half inch, ¾ inch, and one inch fittings, respectively, are only one example of the possible colors which may be selected for each fitting size. These colors may alternatively be used for different fitting sizes, e.g. with half inch fittings in green, ¾ inch fittings in yellow, and one inch fittings in red, or one or more different colors may be selected for one or more of the different fitting sizes in alternative embodiments.

In the above embodiment, the entire fitting is made of a material of the selected color, for example by adding an appropriate dye to the material used to make such fittings. In one embodiment, the fittings are made of appropriately colored plastic material. This avoids the risk of an outer coating wearing off so that the color cannot be readily determined. However, in alternative embodiments, the selected color may be applied as an outer coating of paint or the like covering part or all of the outer surface of the fitting, as long as the coating is one which is not easily removed,

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A system for identifying different-sized irrigation fittings, comprising:
a plurality of irrigation fittings of the same shape and configuration and at least three different sizes, the fittings comprising a plurality of first fittings of a first size, a plurality of second fittings of a second size different from the first size, and a plurality of third fittings of a third size different from the first and second sizes;
each fitting having an outer surface;
each of the first fittings having a first selected identifying color over at least part of the outer surface of the fitting;
each of the second fittings having a second selected identifying color over at least part of the outer surface of the fitting;
each of the third fittings having a third selected identifying color over at least part of the outer surface of the fitting; and
the first, second and third identifying colors corresponding to the first, second and third fitting size, respectively.

2. The system of claim 1, wherein the fittings are selected from the group consisting of elbows, tees, adapters, and hose couplings.

3. The system of claim 1, further comprising at least one additional type of irrigation fitting having at least three different sizes, wherein additional fittings of the first size have the first identifying color, additional fittings of the second size have the second identifying color, and additional fittings of the third size have the third identifying color.

4. The system of claim 1, wherein the first fittings are made entirely of material having the first color, the second fittings are made entirely of material having the second color, and the third fittings are made entirely of material having the third color.

5. The system of claim 4, wherein each fitting is of colored plastic material.

6. The system of claim 1, further comprising a first container containing a plurality of first fittings of the first color, a second container containing a plurality of second fittings of the second color, and a third container containing a plurality of third fittings of the third color.

7. The system of claim 1, wherein the first fittings are one half inch fittings, the second fittings are three quarter inch fittings, and the third fittings are one inch fittings.

8. The system of claim 1, wherein each fitting has a through bore.

9. A method of identifying the size of an irrigation fitting in a set of irrigation fittings of the same type but different sizes, comprising:
placing a plurality of first irrigation fittings of a first size in a first container, at least an external part of each first irrigation fitting having a first identifying color to identify the first size;
placing a plurality of second irrigation fittings of the same type as the first irrigation fittings and of a second size different from the first size in a second container, at least an external part of each second irrigation fitting having a second identifying color different from the first identifying color to identify fittings of the second size;
placing a plurality of third irrigation fittings of the same type as the first and second irrigation fittings and of a third size different from the first and second size in a third container, at least an external part of each third irrigation fitting having a third identifying color different from the first and second identifying color to identify fittings of the third size;
whereby each color represents a predetermined fitting size; and
selecting one or more fittings of a desired size by determining the color corresponding to the desired fitting size and selecting fittings from the bin containing fittings of the determined color.
